(19) United States
(12) Patent Application Publication
(10) Pub. No.: US 2026/0250190 A1
(43) Pub. Date: Aug. 27, 2026

(54) CEMENT COMPOSITIONS AND METHODS OF MAKING THE SAME FROM WASTE

(71) Applicants: The Board of Trustees of The University of Alabama, Tuscaloosa, AL (US); Washington University, St. Louis, MO (US)

(72) Inventors: Jialai Wang, Tuscaloosa, AL (US); Xinhua Liang, St. Louis, MO (US)

(21) Appl. No.: 19/549,463

(22) Filed: Feb. 25, 2026

Related U.S. Application Data
(60) Provisional application No. 63/763,964, filed on Feb. 27, 2025.

(51) Int. Cl. C04B 7/26; C04B 7/22; C04B 7/24; C04B 7/43; C04B 11/30; C04B 28/02; C04B 28/14; C04B 40/02; C04B 111/00; C04B 111/94

(52) U.S. Cl. CPC C04B 7/26; C04B 7/22; C04B 7/246; C04B 7/434; C04B 11/30; C04B 28/021; C04B 28/14; C04B 40/0259; C04B 2111/00017; C04B 2111/00465; C04B 2111/94; C04B 2201/52

(57) ABSTRACT

Disclosed herein is a method comprising: (a) calcining a feedstock material in a reactor; wherein the feedstock material comprises: (i) a metal-containing solid material and/or a metal oxide-containing solid material, and (ii) a reactive gas configured to react to form a solid carbon, wherein the reactive gas comprises a methane and optionally carbon dioxide and/or carbon monoxide; wherein calcining is performed at a temperature of 500° C. to 1450° C.; (b) forming a first amount of hydrogen and a supplementary cementitious material (SCM), wherein the supplementary cementitious material comprises a solid carbon dispersed within the metal-containing solid material and/or the metal oxide containing solid material. Additionally, disclosed are SCMs formed by the disclosed methods, concrete compositions comprising the disclosed SCMs, and articles comprising the disclosed concrete compositions. Also disclosed are methods of recycling the disclosed concrete compositions.

### CROSS-REFERENCE TO RELATED APPLICATIONS

The present application claims the benefit of Provisional Application No. 63/763,964, filed on Feb. 27, 2025, the content of which is incorporated in its whole entirety by reference.

### FIELD

The subject matter disclosed herein generally relates to a cement produced from waste streams as feedstocks.

### BACKGROUND

Concrete with ordinary Portland cement (OPC) as the main binder is the most widely used construction material in the world. However, the concrete industry has a significant impact on the environment. The production of OPC is highly energy-intensive and responsible for approximately 8% of global CO₂ emissions. This is an unsustainable burden on energy requirements and CO₂ emissions, especially for a material manufactured at a scale of >4.5 billion tons per year. Numerous strategies have been proposed to reduce the heavy environmental impact of concrete, as summarized in the roadmap for net-zero concrete by the Global Cement and Concrete Association (GCCA). These strategies include reducing OPC's carbon emissions, replacing OPC with supplementary cementitious materials (SCMs), capturing CO₂ at cement plants, reusing and extending the life of concrete, enhancing performance with nanotechnology, and using hydrogen as a fuel.

Each of these methods faces significant challenges. For example, electrifying OPC manufacturing can significantly reduce carbon emissions. In an electrochemically based approach, instead of calcining limestone to release CO₂, electricity is used to drive reactions that decarbonize limestone while simultaneously capturing and utilizing the emitted CO₂. By eliminating emissions from both the chemical reactions and the energy source, this method enables the production of carbon-neutral cement. However, the electrochemical process is highly energy-intensive compared to traditional methods and must depend on renewable energy sources to achieve meaningful carbon reductions. Moreover, scaling up this technology remains a considerable challenge, requiring advancements in infrastructure, process efficiency, and economic feasibility to make it a viable alternative at an industrial scale.

Using supplementary cementitious materials (SCMs) to replace OPC is one of the most practical and effective ways to reduce the carbon emissions associated with concrete production. However, the availability of traditional SCMs, such as fly ash and blast furnace slag, is steadily declining due to reduced coal-fired power generation and the shift away from conventional steelmaking processes. Although alternatives such as calcined clay can be produced from widely available raw materials like clay, they still consume large amounts of virgin resources and energy.

Thus, new methods and compositions are needed to reduce the carbon footprint of concrete manufacture. Such compositions and methods should also permit the strength and durability of the concrete to be maintained while eliminating the difficulties encountered in existing approaches. The compositions and methods disclosed herein address these and other needs.

### SUMMARY

In accordance with the purposes of the disclosed materials, compounds, compositions, and methods, as embodied and broadly described herein, the disclosed subject matter, in one aspect, relates to compounds and compositions and methods for preparing and using such compounds and compositions.

In some aspects disclosed herein is a method comprising: (a) calcining a feedstock material in a reactor; wherein the feedstock material comprises: (i) a metal-containing solid material and/or a metal oxide-containing solid material, and (ii) a reactive gas configured to react to form a solid carbon, wherein the reactive gas comprises a methane and optionally carbon dioxide and/or carbon monoxide; wherein calcining is performed at a temperature of 500° C. to 1450° C.; (b) forming a first amount of hydrogen and a supplementary cementitious material (SCM), wherein the supplementary cementitious material comprises the solid carbon dispersed within the metal-containing solid material and/or metal oxide containing solid material.

In some aspects, the metal-containing solid material and/or the metal oxide-containing solid material comprises one or more transition metals or oxides thereof.

Yet, in some aspects, the solid carbon comprises carbon nanotubes, carbon nanofibers, carbon fibers, graphite, carbon flakes, amorphous carbon, graphene, or any combination thereof.

Still, in further aspects, the metal-containing solid material and/or the metal oxide-containing solid material further comprises an amount of silicate, an amount of aluminum oxide, or a combination thereof.

Still, in some aspects, the metal-containing solid material and/or the metal oxide-containing solid material comprises industrial waste, mining waste, clay, soil, and minerals comprising at least 0.5% of a metal oxide or any combination thereof.

In some aspects, a volume ratio of reactive gas to the metal-containing solid material and/or the metal-oxide-containing solid material is 0.1:1 to 10000:1.

Also disclosed herein is a blended cement comprising: greater than 0 to less than 100 wt % of cement and greater than 0 to less than 100 wt % of the supplementary cementitious material made by any of the disclosed herein methods based on a total weight of the blended cement.

Also disclosed herein is a method of forming a concrete, wherein the

method comprises mixing the disclosed herein blended cement with an amount of aggregates and water to produce the concrete.

Also disclosed herein is an article comprising the concrete formed by any of the disclosed herein methods.

Also disclosed herein is a supplementary cementitious material formed by any of the disclosed herein methods.

Still further disclosed herein is a supplementary cementitious material comprising a metal-containing solid material and/or a metal oxide-containing solid material, wherein an amount of solid carbon is dispersed within the metal-containing solid material and/or metal oxide-containing solid material, and wherein the metal-containing solid material and/or metal oxide-containing solid material comprises iron ore tailings, steel slag, copper slag, nickel slag, mine tailings, coal combustion residue, red clay, bauxite residue, cobalt slag, or any combination thereof.

Also disclosed herein is a concrete composition comprising the blended cement of any of the examples herein, an amount of aggregates, and water, wherein a weight ratio of water to the blended cement is from 0.1 to less than 1. Disclosed also is an article formed from such a concrete composition.

Also disclosed herein is a method of recycling of any of the concrete compositions disclosed herein, wherein the method comprises: electrically heating the concrete composition to generate internal heat and thereby forming a concrete composition deformation.

Additional advantages will be set forth in part in the description that follows, and in part will be evident from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 is a schematic illustrating exemplary processes disclosed herein in some aspects.

FIG. 2A depicts the effect of hydrogen reduction temperature on CH₄ conversion.

FIG. 2B depicts CNT mass vs reaction time.

FIGS. 3A-3D depict TEM images of CNT growth on fly ash particles. FIG. 3A shows CNT growth after 10 min; FIG. 3B shows CNT growth after 15 min; FIG. 3C shows CNT growth after 1 h, and FIG. 3D shows CNT growth after 3 h.

FIGS. 4A-4C depict CNTs grown on waste particles. FIG. 4A shows supplementary cementitious materials produced with fly ash as a feedstock. FIG. 4B shows CNTs grown on the fly ash particle, and FIG. 4C shows the Raman spectrum, indicating the presence of CNTs.

FIGS. 5A-5B depict supplementary cementitious materials produced using red clay. FIG. 5A after 30 min reaction and FIG. 5B after 2 h of reaction.

FIG. 6 depicts a comparison of the compressive strength of cement mortar control and a blended cement mortar with 15% of supplementary cementitious materials made with fly ash according to one aspect.

FIGS. 7A-7B depict self-sensing testing of the cement mortar. FIG. 7A shows a schematic of the specimen and FIG. 7B shows the testing setup.

FIG. 8 shows periodic loading and current intensity measured for a self-sensing specimen with CNT-grown fly ash at the age of 28 days.

FIG. 9 shows a plot illustrating self-sensing induced by the supplementary cementitious materials according to one aspect.

### DETAILED DESCRIPTION

The materials, compounds, compositions, articles, and methods described herein may be understood more readily by reference to the following detailed description of specific aspects of the disclosed subject matter and the Examples included therein.

Before the present materials, compounds, compositions, kits, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entirety are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### Definitions

In this specification and in the claims that follow, reference will be made to a number of terms, which shall be defined to have the following meanings:

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as” and grammatical equivalences thereof, the phrase “and without limitation” is understood to follow unless explicitly stated otherwise. It is further understood that these phrases are used for explanatory purposes only. It is further understood that the term “exemplary,” as used herein, means “an example of” and is not intended to convey an indication of a preferred or ideal aspect.

The term “or” means “and/or.”

Recitation of ranges of values is merely intended to serve as a shorthand method of referring individually to each separate value falling within the range unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context.

All disclosed values also include values that fall within ±10% variation from the disclosed value unless otherwise indicated or inferred. In other words, if a range of 1 to 10 is disclosed, then a range of about 1 to about 10 is disclosed. In such aspects, it is understood that the amount or value in question can be the exact value or a value that provides equivalent results or effects as recited in the claims or taught herein. That is, amounts, sizes, formulations, parameters, and other quantities and characteristics include both exact values but also approximate, larger, or smaller values as desired, reflecting tolerances, conversion factors, rounding, measurement error, and the like, and other factors known to those of skill in the art such that equivalent results or effects are obtained. In some circumstances, the value that provides equivalent results or effects cannot be reasonably determined. In general, an amount, size, formulation, parameter, or other quantity or characteristic is “about,” “approximate,” or “at or about,” whether or not expressly stated to be such. Where “about,” “approximate,” or “at or about” is used before a quantitative value, the parameter also includes the specific quantitative value itself unless expressly stated otherwise.

As used herein, the term or phrase “effective,” “effective amount,” or “conditions effective to” refers to such amount or condition that is capable of performing the function or property for which an effective amount or condition is expressed. As will be pointed out below, the exact amount or particular condition required will vary from one aspect to another, depending on recognized variables such as the materials employed and the processing conditions observed. Thus, it is not always possible to specify an exact “effective amount” or “condition effective to.” However, it should be understood that an appropriate, effective amount will be readily determined by one of ordinary skill in the art.

When a range is expressed, a further aspect includes from the one particular value and to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘x, y, z, or less’ and should be interpreted to include the specific ranges of ‘x,’ ‘y,’ ‘z,’ ‘about x,’ ‘about y,’ and ‘about z’ as well as the ranges of ‘less than x,’ ‘less than y, or ‘less than z,’ or ‘less than about x,’ ‘less than about y, and ‘less than about z.’ Likewise, the phrase‘x, y, z, or greater’ should be interpreted to include the specific ranges of ‘x,’ ‘y,’ ‘z,’ ‘about x,’ ‘about y,’ and ‘about z’ as well as the ranges of ‘greater than x,’ greater than y, ‘greater than z,’ or ‘greater than about x,’ greater than about y, ‘greater than about z.’ In addition, the phrase“ ‘x’ to ‘y’,” where ‘x’ and ‘y’ are numerical values, also includes “about ‘x’ to about ‘y’.”

Such a range format is used for convenience and brevity and, thus, should be interpreted flexibly to include not only the numerical values explicitly recited as the limits of the range but also to include all the individual numerical values or sub-ranges encompassed within that range as if each numerical value and sub-range is explicitly recited. To illustrate, a numerical range of “0.1% to 5%” should be interpreted to include not only the explicitly recited values of 0.1% to 5% but also include individual values (e.g., 1%, 2%, 3%, and 4%) and the sub-ranges (e.g., 0.5% to 1.1%; 5% to 2.4%; 0.5% to 3.2%, and 0.5% to 4.4%, and other possible sub-ranges) within the indicated range.

Recitation of ranges of values herein is merely intended to serve as a shorthand method of referring individually to each separate value recited or falling within the range unless otherwise indicated herein, and each separate value is incorporated into the specification as if it were individually recited. Ranges provided herein are understood to be shorthand for all of the values within the range. For example, a range of 1 to 50 is understood to include any number, or combination of numbers, from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 or sub-ranges from the group consisting of 10-40, 20-50, 5-35, etc. Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4).

As used herein, the term “composition” is intended to encompass a product comprising the specified ingredients in the specified amounts, as well as any product that results, directly or indirectly, from a combination of the specified ingredients in the specified amounts.

References in the specification and concluding claims to parts by weight of a particular element or component in a composition denote the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether or not additional components are contained in the mixture.

A weight percent (wt. %) of a component, unless specifically stated to the contrary, is based on the total weight of the formulation or composition in which the component is included.

As used herein, “compound” is intended to refer to a chemical entity, whether as a solid, liquid, or gas, and whether in a crude mixture or isolated and purified.

As used herein, “composite” refers to a combination of two or more distinct constituent materials into one. The individual components, on an atomic level, remain separate and distinct within the finished structure. The materials may have different physical or chemical properties that, when combined, produce a material with characteristics different from the original components. In some embodiments, a composite may have at least two constituent materials that comprise the same empirical formula but are distinguished by different densities, crystal phases, or a lack of a crystal phase (i.e., an amorphous phase).

As used herein, the term “plurality” means two or more.

As used herein, the term “mixture” refers to a combination of two or more substances in which each substance retains its own chemical identity and properties. A mixture may be homogeneous, in which the composition is uniform throughout, or heterogeneous, in which the composition varies from one region to another.

As used herein, the term “slurry” refers to a fluid mixture containing solid particles suspended in a liquid. The solid particles in a slurry may be partially or fully dispersed throughout the liquid phase and may settle over time if not agitated.

As used herein, the terms “curing” or “setting” refer to the process by which a material hardens, solidifies, or develops its final properties. Curing or setting may occur through chemical reaction, hydration, polymerization, evaporation of a solvent, cooling, or any combination thereof. The terms may be used interchangeably unless the context clearly dictates otherwise.

As used herein, the term “ambient conditions” or “room temperature” refers to the environmental conditions typically present in a standard indoor setting without artificial heating or cooling. In some aspects, ambient conditions or room temperature may refer to a temperature in the range of about 20° C. to about 25° C. (about 68° F. to about 77° F.) and a pressure of about 1 atmosphere (about 101.325 kPa), unless otherwise specified.

As used herein, the term “particle size” refers to a measure of the dimensions of individual particles in a particulate material. Particle size may be expressed as a diameter, an equivalent spherical diameter, or a mesh size. When expressed as a mesh size, the particle size refers to the size of openings in a standard sieve through which particles will or will not pass. Unless otherwise specified, particle size values refer to median particle size (d50) as determined by a standard measurement technique such as laser diffraction, sieve analysis, or dynamic light scattering.

It is understood that if described materials can have various hydration states in a given compound formula unless otherwise noted, a description of the material includes all the hydration states. For example, and without limitations, compounds such as aluminum sulfate, Al₂(SO₄)₃, include anhydrous Al₂(SO₄)₃, Al₂(SO₄)₃ X18H₂O, and any other hydrated forms or mixtures.

As used herein, the term or phrase “cement” refers to a composition or substance with one or more constituents that is capable of binding materials together once set. In certain aspects, cement can include a number of dry constituents chosen based on the desired ratio or class of cement to be produced. Thus, cement refers to the dry, pre-set composition unless the context clearly dictates otherwise, for example, in a wet cement slurry or in a cured cement material. It is further understood that the general term “cement” comprises hydraulic cement, non-hydraulic cement, pozzolanic materials, or a combination thereof.

The term “hydraulic cement” refers to any inorganic cement that hardens or sets due to hydration. As used herein, the term “hydraulically-active” refers to properties of a cement material that allow the material to set in a manner like hydraulic cement, either with or without additional activation. Hydraulic cements, for instance, include Portland cements, aluminous cements, pozzolan cements, fly ash cements, and the like. Thus, for example, any of the oil well type cements of the class “A-H” as listed in the API Spec 10, (1st ed., 1982) are suitable hydraulic cements.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount. It is understood that this definition also includes the ranges when no word “about” is present.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition or based on any other calculations as disclosed. It is understood that this definition also includes the ranges when the word “about” is not present.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to. It is understood that this definition also includes the ranges when no word “about” is present.

As used herein, the terms “substantially identical reference composition” and “substantially identical reference article” refer to a reference composition or article comprising substantially identical components in the absence of an inventive component. In another exemplary aspect, the term “substantially,” in, for example, the context “substantially identical reference composition” or “substantially identical reference article,” refers to a reference composition or an article comprising substantially identical components and wherein an inventive component is absent or is substituted with a common in the art component.

By “contact” or other forms of the word, such as “contacted” or “contacting,” it is meant to add, combine, or mix two or more compounds, compositions, or materials under appropriate conditions to produce a desired product or effect. The term “react” is sometimes used when “contacting” results in a chemical reaction.

As used herein, the term “configured to” or “adapted to” refers to a structure or arrangement of elements that are designed or arranged to perform a particular function or operation. The terms indicate that the element has the necessary structure, capability, or arrangement to perform the recited function, and do not require that the element be actively performing that function at all times.

As used herein, the terms “coupled” or “connected” refer to a relationship between two or more elements wherein the elements are in communication with one another, either directly or indirectly through one or more intermediate elements. The coupling or connection may be mechanical, electrical, thermal, fluidic, or any combination thereof, unless the context clearly dictates otherwise. A “direct” coupling or connection indicates that no intermediate elements are present between the coupled or connected elements.

While aspects of the present invention can be described and claimed in a particular statutory class, such as the system statutory class, this is for convenience only, and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that is possible are specifically contemplated unless specifically indicated to the contrary. Thus, if a class of components A, B, and C are disclosed, and a class of components D, E, and F and an example of a combination composition A-D are disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from the disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure, including, but not limited to, steps in methods of making and using the disclosed compositions. Thus, if there are a variety of additional steps that can be performed, it is understood that each of these additional steps can be performed with any specific aspect or combination of aspects of the disclosed methods, and that each such combination is specifically contemplated and should be considered disclosed.

As discussed in detail above, concrete is one of the most utilized compounds in the world. However, conventional concretes suffer from a few inherent weaknesses, such as low tensile strength, high brittleness, and low volume stability. Therefore, they are vulnerable to cracking, which can trigger multiple deterioration mechanisms because cracks allow harmful chemicals to migrate into concrete. One promising solution to this problem is to reinforce the concrete with micro or nanofibers. However, micro-sized reinforced materials can only mitigate the expansion of internal microcracks in cement-based materials rather than preventing their formation.

It was suggested to use carbon-based materials as reinforcing materials to achieve higher strength and longer service life. For example, it was shown in the past that the incorporation of 0.5 wt. % carbon nanotubes (CNTs) into the concrete can improve flexural, compressive strengths, and the failure strain of the concrete by 25%, 19%, and 27%, respectively.

Although extensive studies have been conducted over the past two decades, the practical application of CNTs in concrete has been hampered by three significant challenges: achieving proper dispersion, scaling up laboratory results and implementing them at larger scales, and cost.

Due to strong van der Waals forces between CNTs, they readily agglomerate into bundles and ropes. It has been shown that poor dispersion and rope-like entanglement of CNTs can weaken composites significantly. A homogeneous dispersion of CNTs into the matrix is the key to reaching an ideal reinforcing effect. The primary physical method, ultrasonication, often combined with surfactants, is used for dispersing CNTs. Chemical approaches involve covalent and noncovalent treatments. However, prolonged ultrasonication can damage CNTs; surfactants may hinder the formation of conductive networks; and functionalization may introduce structural defects. Thus, there is a need to enhance CNT dispersion without compromising their properties and to develop more stable, sensitive CNT-based concrete sensors.

Here disclosed are methods that allow in-situ growth of a solid carbon on the particles of cementitious materials, thereby eliminating the difficult task of dispersing carbon-based materials. The disclosed methods result in solid carbon being self-dispersed into the matrix by the cementitious particles on which they are grown.

As shown below, a 100% increase in compressive strength can be achieved for cement paste to be reinforced in this manner, indicating that this new approach is more effective than existing dispersion methods.

In-situ growth of solid carbon eliminates the difficult dispersion process, making it possible to produce solid carbon integrated concrete using existing mixing equipment. Its high production cost makes large-scale applications economically infeasible. Compared with materials used in other areas, civil infrastructure materials are used in much larger volumes. Reinforcing bulky construction materials requires large amounts of solid carbon, such as CNTs, even at very low loading fractions. The high demand for CNTs poses two challenges: 1) scaling up the current manufacture of CNTs to provide sufficient supply (in MMTs), and 2) lowering the cost of CNTs. The disclosed herein methods eliminate or at least substantially solve these challenges.

In certain aspects, disclosed herein is a method comprising: (a) calcining a feedstock material in a reactor; wherein the feedstock material comprises: (i) a metal-containing solid material and/or a metal oxide-containing solid material, and (ii) a reactive gas configured to react to form a solid carbon, wherein the reactive gas comprises a methane and optionally carbon dioxide and/or carbon monoxide; wherein the calcining is performed at a temperature of 500° C. to 1450° C.; (b) forming a first amount of hydrogen and a supplementary cementitious material (SCM), wherein the supplementary cementitious material comprises the solid carbon dispersed within the metal-containing solid material and/or the metal oxide-containing solid material.

In still further aspects, the calcining can be performed at a temperature of 500° C. to 1450° C., including exemplary values of 600° C., 700° C., 800° C., 900° C., 1000° C., 1100° C., 1200° C., 1300° C., and 1400° C. It is understood that the calcining temperature can have any value between any two foregoing values or fall within a range formed by any two foregoing values. In yet still further aspects, the calcining temperature can be 500° C. to 1400° C., 500° C. to 1350° C., 500° C. to 1300° C., 500° C. to 1200° C., 500° C. to 1100° C., 500° C. to 1000° C., 500° C. to 900° C., 500° C. to 800° C., 500° C. to 700° C., 600° C. to 1450° C., 800° C. to 1450° C., 1000° C. to 1450° C., 1250° C. to 1450° C., and so on.

In certain aspects, the reactive gas comprises methane.

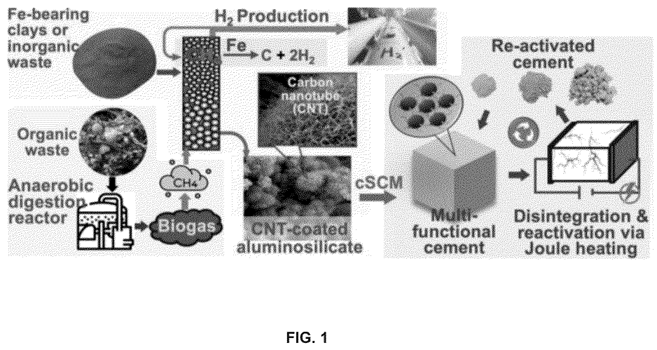

The exemplary schematic of the disclosed process is shown in FIG. 1. The feedstocks are combined and calcined in a reactor. In certain aspects, the reactive gas comprises methane. In such exemplary and unlimiting aspects, after heating to a certain temperature, CH₄ molecules decompose into H₂ gas and solid carbon, as given by Eq. (1)

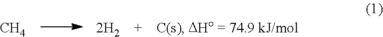

For example, the presence of iron-containing industrial waste or red clay can catalyze the thermal cracking process, reducing the temperature required for CH₄ decomposition and enhancing the conversion rate of CH₄. This leads to lower energy consumption for the reaction. The solid carbon can grow on the surface of the catalyst particles.

It is understood that at the disclosed temperatures, the methane gas can undergo pyrolysis, and thus, a first amount of hydrogen is formed in the gas phase. Also, as a result of pyrolysis the solid carbon is formed and is dispersed on the supplementary cementitious material.

Yet in other aspects, the reactive gas can further optionally comprise carbon dioxide and/or carbon monoxide. Yet in still further aspects, the reactive gas can comprise methane and carbon dioxide. In such exemplary and unlimiting aspects, carbon dioxide and methane can react to dry reform methane according to Eq. 2.

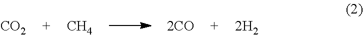

The formed CO (carbon monoxide) can further react at the conditions described herein to form solid carbon and carbon dioxide according to Eq. 3:

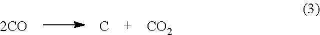

In still further aspects, the first amount of hydrogen gas can be collected. The first hydrogen gas can be formed from pyrolysis of CH₄ and/or from dry reforming of CH₄.

In certain aspects, the first amount of hydrogen gas can be separated from the unreacted CH₄ (or other components of the reactive gas) using palladium membrane at 300-500° C. or other membranes and then collected. In still further aspects, the collected hydrogen gas can be used for any desired purpose. For example, and without limitations, a portion of the first amount of the hydrogen gas can be used to heat the reactor to the desired temperature. Such uses of the formed hydrogen gas allow the process to be energy-positive.

H₂ serves as a versatile energy carrier and chemical feedstock, uniquely bridging the nation's diverse energy resources, such as renewables, nuclear, and fossil fuels. It fosters innovation in energy production and utilization, facilitating the decarbonization of three pivotal sectors: transportation, electricity generation, and manufacturing, all of which are major energy consumers.

In certain aspects, the metal-containing solid material and/or the metal oxide-containing solid material comprises one or more transition metals or oxides thereof. In such exemplary and unlimiting aspects, the transition metal or oxide thereof can comprise iron, nickel, cobalt, copper, or any combination thereof. It is further understood that if the metal is present as oxide, the metal can be present in any possible valencies and form stoichiometric oxides accordingly.

In still further aspects, the metal-containing solid material and/or the metal oxide-containing solid material further comprises an amount of silicate, an amount of aluminum oxide, or a combination thereof. Without wishing to be bound by any theory, it is assumed that silicates and aluminum oxide or other oxides can serve as a support material for solid carbon growth. The high temperature required for pyrolysis can cause the loss of the crystalline structure of silicates in the waste, resulting in the formation of reactive silicate phases and converting waste into pozzolanic materials that can be used as new supplementary cementitious materials (SCMs).

In still further aspects, the solid carbon can comprise carbon nanotubes, carbon nanofibers, carbon fibers, graphite, or any combination thereof. The solid carbon can also be presented as carbon flakes, amorphous carbon, graphene, or any combination thereof. While some of the examples disclosed below show the growth of the carbon nanotube on the metal-containing and/or the metal oxide-containing materials, it is understood that any other solid carbon material can also be grown by the methods disclosed herein.

In certain aspects, the metal-containing solid material and/or the metal oxide-containing solid material can be sourced from any available sources. For example, the metal-containing solid material and/or the metal oxide-containing solid material can comprise industrial waste, mining waste, clay, soil, and minerals comprising at least 0.5% of a metal oxide, or any combination thereof. In still further exemplary aspects, the metal-containing solid material and/or the metal oxide-containing solid material can comprise iron ore tailings, steel slag, copper slag, nickel slag, mine tailings, coal combustion residue, red clay, bauxite residue, cobalt slag, or any combination thereof.

It is understood that in certain aspects, these materials can be present as received. Yet in still further aspects, the metal-containing solid material and/or metal oxide-containing solid material can be processed before use in the disclosed methods. It is understood that, in certain aspects, the processing can comprise grinding, crushing, chemical etching, or any combination thereof of the original material prior to using it in the disclosed methods. In still further aspects, the metal-containing solid material and/or the metal oxide-containing solid material can comprise a plurality of particles.

In still further aspects, the plurality of particles can be of any size, for example, 1 nm to 1000 microns, 1 nm to 800 microns, 1 nm to 500 microns, 1 nm to 250 microns, 1 nm to 100 microns, 1 nm to 80 microns, 1 nm to 50 microns, 1 nm to 25 microns, 1 nm to 10 microns, 1 nm to 1 micron, 1 nm to 800 nm, 1 nm to 500 nm, 1 nm to 250 nm, 1 nm to 100 nm, 1 nm to 50 nm, 1 nm to 10 nm, 10 nm to 1000 microns, 50 nm to 1000 microns, 80 nm to 1000 microns, 100 nm to 1000 microns, 250 nm to 1000 microns, 500 nm to 1000 microns, 800 nm to 1000 microns, 1 micron to 1000 microns, 10 microns to 1000 microns, 50 microns to 1000 microns, 80 microns to 1000 microns, 100 microns to 1000 microns, 250 microns to 1000 microns, 500 microns to 1000 microns, 800 microns to 1000 microns, 10 nm to 10 microns, 100 nm to 1 micron, 10 nm to 200 nm, 100 nm to 1 micron and so on.

In still further aspects, the solid carbon can grow on the surface of a plurality of particles of the metal-containing solid material and/or metal oxide-containing solid material. In certain cases, one or more metal oxides can be reduced to metals and serve as catalysts for methane pyrolysis. In additional aspects, methane can reduce metal oxides to metals, thereby further catalyzing methane pyrolysis. In other words, methane pyrolysis can be self-catalyzed by methane gas, reducing metal oxides to the metal. Yet in other aspects, the metal-containing solid material and/or metal oxide-containing solid material can serve as catalysis for the dry reforming of methane and reduction of carbon monoxide to form solid carbon.

In still further aspects, the reactive gas can be sourced from natural sources, agriculture processing, fossil fuels processing, landfills, industrial processing, combustion processing, or any combination thereof.

In certain aspects, the metal-containing solid material and/or the metal oxide-containing solid material behave as the first catalyst to form the solid carbon.

In certain aspects, one or more metal oxides can be reduced to metal and serve as a catalyst for methane pyrolysis and/or for the dry reforming of methane and reduction of carbon monoxide to form solid carbon.

In certain aspects, the metal-containing solid material and/or metal oxide-containing solid material can also be pretreated. In such aspects, the metal-containing solid material and/or metal oxide-containing solid material can be processed first before pretreatment, or it can be used as received for pretreatment.

For example, in some aspects, the method can comprise adding a second amount of hydrogen to the reactor. It is understood that the second amount of hydrogen is added before the addition of the reactive gas, or after the addition of the reactive gas, or both. In certain exemplary aspects, the metal-containing solid material and/or metal oxide-containing solid material is pretreated with the second amount of hydrogen gas at temperatures of 400° C.-1000° C. for a predetermined time before exposure to the reactive gas. During such an exemplary and unlimiting pretreatment, the metal-containing solid material and/or metal oxide-containing solid material can be exposed to the second amount of hydrogen gas at temperatures of 400° C.-1000° C., 400° C.-800° C., 400° C.-600° C., 500° C.-800° C., 600° C.-1000° C., 800°° C.-1000° C., and so on for a predetermined time. In such exemplary aspects, the predetermined time can be from 1 min to 50 h, 10 min to 50 h, 30 min to 50 h, 40 min to 50 h, 1 h to 50 h, 2 h to 50 h, 3 h to 50 h, 5 h to 50 h, 10 h to 50 h, 20 h to 50 h, 1 min to 30 h, 1 min to 20 h, 1 min to 10 h, 1 min to 5 h, 1 min to 3 h, 1 min to 2 h, 1 min to 1 h, 1 min to 30 min, 30 min to 5 h, 10 min to 3 h, and so on.

In certain exemplary and unlimited aspects, the reactor can further comprise an amount of a second catalyst that is added separately, and wherein the second catalyst is substantially different from the first catalyst. It is understood that, in certain aspects, it can be done to accelerate the pyrolysis of methane or the dry reforming of methane and the reduction of carbon monoxide to form solid carbon, if desired.

In still further aspects, in the methods disclosed herein, a volume ratio of reactive gas to the metal-containing solid material and/or metal-oxide-containing solid material is 0.1:1 to 10000:1, 0.5:1, 1:1, 10:1, 50:1, 100:1, 500:1, 1000:1, 5000:1, and so on.

In still further aspects, the calcining step can be done for 1 min to 100 h, 10 min to 100 h, 30 min to 100 h, 40 min to 100 h, 1 h to 100 h, 2 h to 100 h, 3 h to 100 h, 5 h to 100 h, 10 h to 100 h, 20 h to 100 h, 30 h to 100 h, 50 h to 100 h, 80 h to 100 h, 1 min to 80 h, 1 min to 50 h, 1 min to 30 h, 1 min to 20 h, 1 min to 10 h, 1 min to 5 h, 1 min to 3 h, 1 min to 2 h, 1 min to 1 h, 1 min to 30 min, 30 min to 5 h, 10 min to 3 h, and so on.

In still further aspects, the reactor can be any reactor that allows substantial contact between the reactive gas, and the metal-containing solid material and/or metal-oxide-containing solid material. For example, without limitation, the reactor is a fluidized-bed reactor. Yet, in other aspects, the reactor is a flow reactor. Still, in further aspects, the reactor is a continuous reactor (e.g., roll-to-roll reactors or moving vibrating reactors) for a solid-gas contact.

In still further aspects, the supplementary cementitious material formed by the disclosed methods exhibits pozzolanic reactivity. It is understood that the pozzolanic reactivity (as described in ASTM C595/C595M-17, 2017) can be defined by the ability of a material, in finely divided form, to react with calcium hydroxide (lime, CH) in the presence of moisture to produce the binding product calcium-silicate-hydrate (CSH) in cementitious systems, even if it does not have the binding property of its own.

It is understood that the presence of the solid carbon dispersed within the supplementary cementitious material, in addition to improvement in mechanical properties, can drastically increase the conductivity of the concrete due to its excellent electrical conductivity. Thus, disclosed are aspects where the supplementary cementitious material is at least partially electrically conductive.

Without wishing to be bound by any theory, it is understood that the conductive pathways can be established in concrete comprising the disclosed herein supplementary cementitious material if the content of the solid carbon, for example, and without limitations, the content of CNTs is above a percolation threshold. With high electrical conductivity, concrete can be self-heated through the Joule heating effect for deicing and snow-melting, and space heating for buildings. It also provides a new pathway to electrify building heating systems and offers excellent protection for digital equipment and people from electromagnetic interference (EMI). More importantly, this electrical conductivity varies with the stress/strain, suggesting that the concrete can sense its strain. This self-sensing of strain/damage ability transforms CNT-reinforced concrete into a strain/damage sensor, which can be used in different forms of structures for structural health monitoring (SHM) or in pavement for traffic detection.

Similar to electrical conductivity, adding solid carbon to concrete significantly increases its thermal conductivity, with applications in energy-efficient buildings, renewable energy, and sustainable pavements. Thus, in such exemplary and unlimiting aspects, the disclosed herein supplementary cementitious material can also be at least partially thermally conductive.

In still further aspects, the method of forming the disclosed herein supplementary cementitious material is carbon neutral. The proposed process requires no additional energy input and utilizes reactive gas comprising methane, a potent greenhouse gas, as a feedstock. The methane is sequestered as solid carbon, for example, carbon nanotubes (CNTs), which are directly grown on the surface of the cement particles. This innovative approach not only prevents methane emissions but also locks carbon into a valuable material, resulting in a carbon-negative cement. Similarly, the discloses methods can help sequestrate carbon dioxide by dry reforming of methane and reducing carbon monoxide to solid carbon.

Yet in still further aspects, the method of forming the disclosed herein supplementary cementitious material is resource positive. This cement is produced by utilizing agricultural and industrial waste streams as sole feedstocks, eliminating the need for valuable natural resources like limestone. This not only conserves finite natural resources but also mitigates the environmental burden of waste disposal.

In still further aspects, the method of forming the disclosed herein supplementary cementitious material is energy positive. In traditional cement production, the calcining process is a significant energy consumer, accounting for approximately 40% of the total CO₂ emissions. The disclosed herein processes not only generate enough energy to sustain the calcining process but also produce surplus energy in the form of hydrogen. This energy-positive cycle eliminates the need for external energy inputs and turns cement production into an energy-generating process.

In certain aspects, the SCMs described herein can also be referred to as produced resource-positive, energy-positive and carbon-negative cement or “recCEM.”

In still further aspects, it is understood that the method of forming the disclosed herein supplementary cementitious material can be easily scaled up and provide any desired amount of supplementary cementitious material.

Also disclosed herein is supplementary cementitious material formed by the methods of any of the examples herein.

In certain aspects, disclosed is a supplementary cementitious material comprising a metal-containing solid material and/or metal oxide-containing solid material, wherein an amount of solid carbon is dispersed within the metal and/or metal oxide-containing solid material, and wherein the metal and/or metal oxide-containing solid material comprises iron ore tailings, steel slag, copper slag, nickel slag, mine tailings, coal combustion residue, red clay, bauxite residue, cobalt slag, or any combination thereof. In such exemplary and unlimiting aspects, the supplementary cementitious material is at least partially electrically conductive, thermally conductive, or a combination thereof.

Also disclosed herein is a blended cement comprising: greater than 0 to less than 100 wt % of cement and greater than 0 to less than 100 wt % of the supplementary cementitious material based on the total weight of the blended cement, wherein the supplementary cementitious material is any of the SCMs disclosed herein and any of SCMs made by the disclosed herein methods.

In still further aspects, the cement can comprise Portland cement, a basic ingredient of concrete, mortar, stucco, and non-specialty grout, which is a fine powder produced by heating limestone and clay minerals in a kiln to form clinker, grinding the clinker, and adding small amounts of other materials. Several types of Portland cement can be used, for example, API Class A, Class G, or Class H; Ordinary Portland Cement (OPC) Type I, Type II, Type III, Type IV, or Type V; or a combination thereof (in accordance with the ASTM C150 standard). Portland Cement Type Ia, Type IIa, and/or Type IIIa may also be used, which have the same composition as Types I, II, and III except that an air-entraining agent is ground into the mix (also in accordance with the ASTM C150 standard).

Yet in other aspects, the cement can also comprise hydraulic types of cement, Saudi Class G hydraulic cement, non-hydraulic types of cement, pozzolanic materials such as fly ash, silica-fume, ground granular blast furnace slag, EMC types of cement, stuccos, plastic types of cement, expansive types of cement, white blended types of cement, Pozzolan-lime types of cement, slag-lime types of cement, supersulfated types of cement, calcium aluminate types of cement, calcium sulfoaluminate types of cement, alkaline activated types of cement, Rosendale types of cement, polymer cement, lime and/or pozzolana.

It is understood that the cement can comprise a mixture of two or more different types of cement. For example, the cement can comprise a mixture of hydraulic cement and non-hydraulic cement. Yet, in other aspects, the cement can comprise mixtures of different hydraulic cements and/or different non-hydraulic cements.

In still further aspects, the cement can be present be present in an amount greater than 0 to less than 100 wt %, for example, from greater than or equal to 0.01 wt % to less than 100 wt %, from greater than or equal to 0.1 wt % to less than 100 wt %, from greater than or equal to 0.5 wt % to less than 100 wt %, from greater than or equal to 1 wt % to less than 100 wt %, from greater than or equal to 5 wt % to less than 100 wt %, from greater than or equal to 10 wt % to less than 100 wt %, from greater than or equal to 20 wt % to less than 100 wt %, from greater than or equal to 50 wt % to less than 100 wt %, from greater than or equal to 60 wt % to less than 100 wt %, from greater than or equal to 80 wt % to less than 100 wt %, from greater than or equal to 90 wt % to less than 100 wt %, greater than 0 to less than or equal to 90 wt %, greater than 0 to less than or equal to 80 wt %, greater than 0 to less than or equal to 60 wt %, greater than 0 to less than or equal to 50 wt %, greater than 0 to less than or equal to 40 wt %, and so on.

In still further aspects, the disclosed herein supplementary cementitious material can be present in an amount of greater than 0 to less than 100 wt %, %, for example, from greater than or equal to 0.01 wt % to less than 100 wt %, from greater than or equal to 0.1 wt % to less than 100 wt %, from greater than or equal to 0.5 wt % to less than 100 wt %, from greater than or equal to 1 wt % to less than greater than 100 wt %, from greater than or equal to 5 wt % to less than 100 wt %, from greater than or equal to 10 wt % to less than 100 wt %, from greater than or equal to 15 wt % to less than 100 wt %, from greater than or equal to 20 wt % to less than 100 wt %, from greater than or equal to 25 wt % to less than 100 wt %, from greater than or equal to 30 wt % to less than 100 wt %, from greater than or equal to 40 wt % to less than 100 wt %, from greater than or equal to 50 wt % to less than 100 wt %, from greater than or equal to 60 wt % to less than 100 wt %, from greater than or equal to 80 wt % to less than 100 wt %, from greater than or equal to 90 wt % to less than 100 wt %, greater than 0 to less than or equal to 90 wt %, greater than 0 to less than or equal to 80 wt %, greater than 0 to less than or equal to 60 wt %, greater than 0 to less than or equal to 50 wt %, greater than 0 to less than or equal to 40 wt %, and so on.

In still further aspects, the blended cement can further comprise greater than 0 to less than 50 wt % of limestone and greater than 0 to less than 20 wt % of gypsum-based on the total weight of the blended cement.

In still further aspects, the blended cement can comprise a ratio of the disclosed herein supplementary cementitious material to the cement, e.g., Portland cement of 0.05 to 5, 0.1 to 5, 0.5 to 5, 1 to 5, 2 to 5, and so on. Yet in still further aspects, the majority of the blended cement can be represented by the supplementary cementitious material. Yet in still further aspects, the blended cement is substantially free of the cement (the cement is substantially substituted by the disclosed supplementary cementitious material).

In such exemplary and unlimiting aspects, the limestone can be present in an amount greater than 0 to less than or equal to 50 wt %, greater than 0 to less than or equal to 40 wt %, greater than 0 to less than or equal to 30 wt %, greater than 0 to less than or equal to 20 wt %, greater than 0 to less than or equal to 10 wt %, greater than or equal to 0.5 to less than or equal to 50 wt %, greater than or equal to 1 to less than or equal to 50 wt %, greater than or equal to 5 to less than or equal to 50 wt %, greater than or equal to 10 to less than or equal to 50 wt %, greater than or equal to 15 to less than or equal to 50 wt %, greater than or equal to 20 to less than or equal to 50 wt %, greater than or equal to 30 to less than or equal to 50 wt %, greater than or equal to 40 to less than or equal to 50 wt %, and so on.

In still further aspects, in such exemplary and unlimiting aspects, the gypsum can be present in an amount of greater than 0 to less than or equal to 20 wt %, greater than 0 to less than or equal to 15 wt %, greater than 0 to less than or equal to 10 wt %, greater than 0 to less than or equal to 5 wt %, greater than 0 to less than or equal to 1 wt %, greater than or equal to 0.1 to less than or equal to 20 wt %, greater than or equal to 0.5 to less than or equal to 20 wt %, greater than or equal to 1 to less than or equal to 20 wt %, greater than or equal to 5 to less than or equal to 20 wt %, greater than or equal to 10 to less than or equal to 20 wt %, and so on.

Still further disclosed herein is a method of making concrete wherein the method comprises mixing the disclosed herein blended cement with an amount of aggregates and water to produce the concrete. It is understood that any aggregates can be used. For example, aggregates can comprise fine aggregates and coarse aggregates. It is understood that the terms fine and coarse aggregates are known in the art. Fine aggregates have an average particle size greater than 75 μm to less than or equal to 4.75 mm, and coarse aggregates have a particle size greater than 4.75 mm. It is understood that the aggregates can be present in the composition in any amount and in any ratio to each other to form the desired article. In certain aspects, the aggregates disclosed herein can be present in 0 to 95 wt %, 0 to 80 wt %, 0 to 70 wt %, 0 to 50 wt %, 10 to 95 wt %, 30 to 95 wt %, 50 to 95 wt %, 80 to 95 wt %, 85 to 90 wt %, 80 to 90 wt %, and so on based on the weight of the concrete.

In still further aspects, the water added to the blended cement is in amount to form a ratio of the water to the blended cement is from 0.1 to less than 1, 0.1-0.8, 0.1-0.7, 0.1-0.6, 0.1-0.5, 0.1-0.4, 0.1-0.3, 0.2-0.8, 0.3-0.8, 0.4-0.8, 0.6-0.8 and so on.

In still further aspects, the concrete further comprises an amount of active agents and/or reagents, fillers, or any combination thereof. In such exemplary and unlimiting aspects, the active agent and/or reagent can comprise a water reducer, a set retarder, a shrinkage-reducing admixture, a workability retaining admixture, a viscosity-adjusting admixture, or any combination thereof. If the active agents and/or reagents are present in such aspects, the amount of those materials can be greater than zero to less than 5 wt %, less than 4 wt %, less than 3 wt %, less than 2 wt %, less than 1 wt % based on the blended cement.

Also disclosed herein is an article (or a component) comprising the concrete formed by any of the disclosed methods. In certain aspects, the article can be formed by casting the concrete, pumping the concrete, or any combination thereof.

In still further aspects, the article disclosed herein can exhibit a compression strength of 500 psi to 25 ksi, 750 psi to 25 ksi, 900 psi to 25 ksi, 1 ksi to 25 ksi, 5 ksi to 25 ksi, 10 ksi to 25 ksi, 15 ksi to 25 ksi, 20 ksi to 25 ksi, 500 psi to 20 ksi, 500 psi to 15 ksi, 500 psi to 10 ksi, 500 psi to 5 ksi, 500 psi to 1 ksi, and so on.

In still further aspects, the disclosed herein article can exhibit a compression strength of at least 7% higher than the compression strength of a substantially identical reference component or article in the absence of the disclosed herein supplementary cementitious material made by the disclosed methods. It is understood, however, that the reference component or article can have other supplementary cementitious materials present.

In still further aspects, the article is at least partially electrically conductive, thermally conductive, or a combination thereof. In still further aspects, the electrical conductivity of the article changes with strain and/or damage. In such aspects, these changes in conductivity can be used to assess the status and the condition of the article.

It is understood that the article can be any article that uses the disclosed herein concrete composition or disclosed herein supplementary cementitious materials. In certain aspects, for example, and without limitations, the article is a building component, a road component, a storage component, a bridge component, or any combination thereof. Also disclosed herein are building components comprising the concrete composition of any of the examples herein. In still further aspects, disclosed herein are building components comprising any of the disclosed articles. It is understood that the building components include construction components, road components, components of any building structures, bridges, storage units, industrial compounds, and so on.

In still further aspects, the concrete composition is recyclable. In yet still further aspects, the concrete compositions described herein can be infinitely recyclable.

Recycling end-of-life concrete as aggregates for new concrete offers an effective way to reduce construction and demolition (C&D) waste while conserving natural resources. However, conventional concrete recycling methods primarily consume large amounts of energy for mechanical processes like crushing and grinding. Additionally, recycled concrete aggregates (RCAs) often have inferior quality compared to natural aggregates (NAs) due to residual, porous cement mortar that remains adhered to the surface of the RCAs. The crushing process can also damage the original aggregates, further compromising the performance and durability of RCAs compared to virgin aggregates. Existing recycling methods also fail to recycle hardened cement paste effectively. Due to its high water absorption and porosity, hardened cement paste cannot be directly reused in new concrete, wasting its potential as a binder.

Traditionally, the hydration of OPC produces calcium silicate hydrate (C-S-H), calcium hydroxide (CH), and other compounds in an irreversible process, making concrete recycling challenging. Use of the recCEM, as disclosed herein, allows a reversible hydration process. When subjected to a controlled electrical current, the recCEM generates heat through the Joule heating effect, efficiently dehydrating the hydrated cement. Without wishing to be bound by any theory, it is assumed that CH breaks down into free CaO while C-S-H transitions into metastable calcium silicates. The breakdown of C-S-H, coupled with the thermal stress generated by Joule heating and the internal pressure generated by water vapor produced during dehydration, can cause the concrete to self-disintegrate. This eliminates the need for energy-intensive crushing process and prevents damage to aggregates. Notably, this process leaves minimal residual cement mortar on the recycled aggregates, substantially improving the quality of the resulting RCAs. Key decomposition products, such as metastable calcium silicates and free CaO, readily react with water to regenerate C-S-H and CH, restoring the binder's functionality. As a result, the dehydrated cement paste can be fully recycled as a reactive cementitious material, serving as a new cement or supplementary cementitious addition to OPC in new concrete. Compared to conventional recycling methods, which rely on heavy machinery and thermal processing, the proposed method—based on self-disintegration enabled by the reversible binder—requires far less energy. Moreover, Joule heating can be powered by renewable electricity, further reducing the environmental impact of the recycling process.

In exemplary and unlimiting aspects, the method to recycle concrete comprises electrically (Joulie) heating the concrete composition to generate internal heat and thereby forming a concrete composition deformation. Yet in still further aspects, the concrete composition deformation comprises a plurality of cracks.

In yet still further aspects, if needed, the method can further comprise mechanical separation of the deformed concrete composition. In such exemplary and unlimiting aspects, the mechanical separation comprises a physical crushing of the concrete composition, crushing by vibration, or any combination hereof.

In still further aspects, the mechanical separation can result in the formation of aggregates and a cement paste that are separated from each other.

Still further, in certain aspects, the method can comprise heating the cement paste to dehydrate hydration products present in the cement paste to form a dehydrated cement paste. In still further aspects, the method can comprise reducing the dehydrated cement paste to a plurality of particles.

In yet still further aspects, the dehydrated cement paste in a new cement composition can be used as a new supplementary cementitious material in new concrete formulations, thus promoting circularity and sustainability (cradle-to-cradle approach).

### EXAMPLES

The following examples are set forth below to illustrate the methods and results according to the disclosed subject matter. These examples are not intended to be inclusive of all aspects of the subject matter disclosed herein but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, and the temperature is in ° C. or is at ambient temperature, and pressure is at or near atmospheric. There are numerous variations and combinations of reaction conditions, e.g., component concentrations, temperatures, pressures, and other reaction ranges and conditions, which can be used to optimize the product purity and yield obtained from the described process. Only reasonable and routine experimentation will be required to optimize such process conditions.

### Example 1

### Producing Supplementary Cementitious Materials With Fly Ash

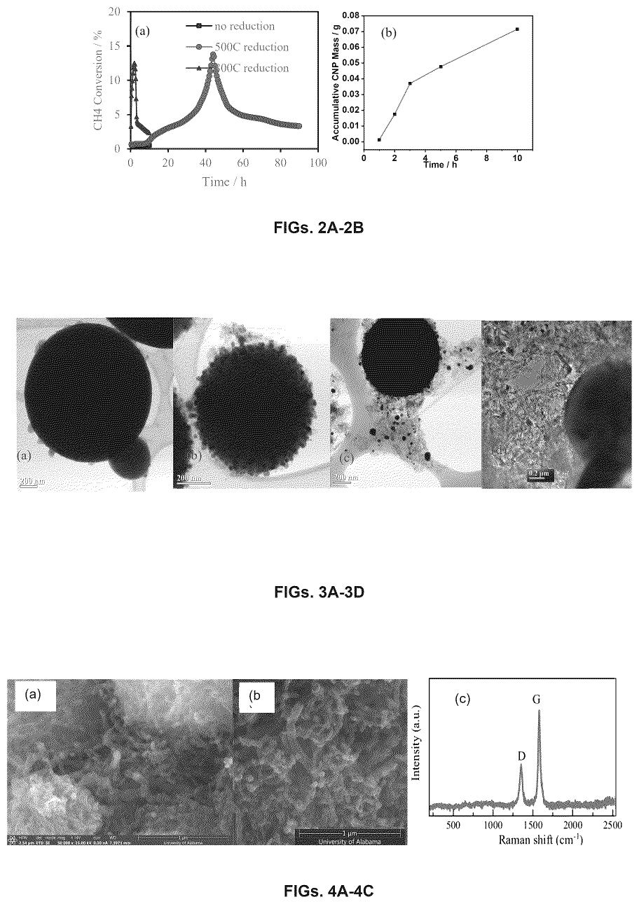

In this example, as-received coal fly ash was used as the catalyst, which was dried without any further treatment. The formation of solid carbon, such as carbon nanotubes, for example, was detected through methane conversion and the formation of reduced hydrogen. To enhance the activity of the catalyst, H₂ was first used to reduce the Fe₂O₃ in the fly ash before the pyrolysis process at two temperatures (i.e., 500° C. and 800° C.). As shown in FIG. 2A, H₂ reduction drastically enhance the reactivity of the catalyst present in the fly ash. There was negligible CH₄ conversion occurring for the fly ash without reduction. With an H₂ reduction temperature of 500° C., CH₄ was slowly converted to CNTs over the first 10 h and increased to a maximum of 14% after approximately 45 h. In contrast, at higher H₂ reduction temperatures of 800° C., CH₄ conversion rapidly reached 12.5% within 2 h. FIG. 2B shows CNTs accumulated on the fly ash particles. The growing process of the CNTs on fly ash particles was revealed by transmission electron microscopy (TEM) shown in FIGS. 3A-3D. Hollow CNTs can be observed on the surface of a fly ash particle after 1 h. Many more CNTs were formed after 3 h. FIGS. 4A-4B depict SEM images of fly ash particles with in-situ grown CNTs. The Raman spectrum (FIG. 4C) of the nanofibers grown on the surface of the fly ash particles confirms their identity as CNTs based on characteristic peaks indicative of CNT structures.

### Example 2

### Producing Supplementary Cementitious Materials, Iron Ore Tailings

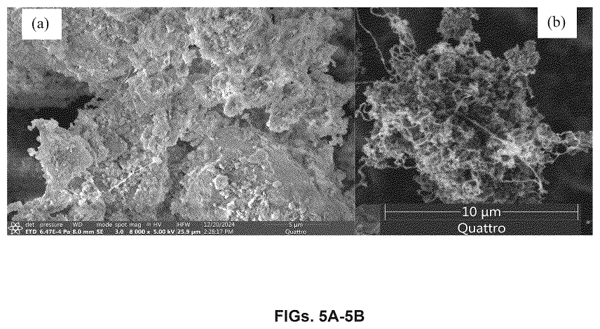

In this example, iron ore tailing containing iron and clay minerals was used as the feedstock, which was dried without any further treatment. By using the proposed method and heating the fluidized bed reactor to 800° C., recCEM was produced, as shown in FIGS. 5A-5B. FIG. 5A shows the tailings particles after calcining at 800° C. for 30 min, and FIG. 5B shows the particles after calcining for 2 h.

### Example 3

### Supplementary Cementitious Materials in Concrete Compositions

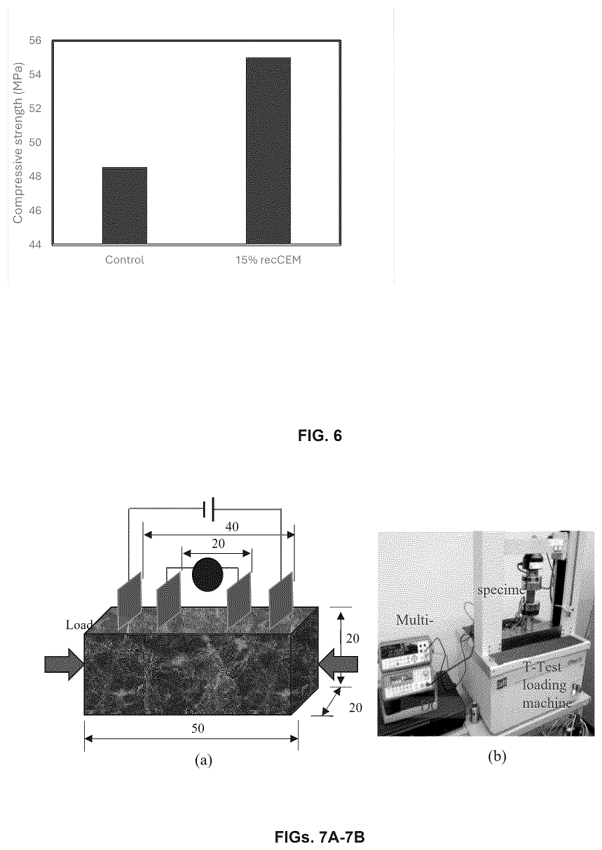

The supplementary cementitious materials synthesized by the methods disclosed herein using fly ash were used to replace 15% of OPC in the production of an exemplary mortar with a water-to-binder ratio of 0.5. In this example the fly ash was first pretreated with hydrogen to reduce metal oxides to metal. A control mortar sample was prepared using 100% OPC with the same water-to-binder ratio. The compressive strengths of both samples were measured at 28 days, and the results are presented in FIG. 6. The data show that despite replacing 15% of the OPC with the synthesized supplementary cementitious material, the compressive strength of the exemplary enhanced mortar is over 13% higher than that of the control sample. This improvement demonstrates the significant reinforcing effect of the in-situ grown CNTs within supplementary cementitious material.

### Example 4

### Self-Sensing Cement Mortar Made With CNT-Integrated Fly Ash Particles

Fly ash grown with CNTs produced using the disclosed method is used to synthesize the cement mortar. The fly ash was first activated by hydrogen treatment. The fly ash particles grown with CNTs are first uniformly blended with the rest cement particles. The resulting blended source materials are then mixed with water and sand to produce cement mortar. CNTs are self-dispersed in the mortar by the fly ash particles. These CNTs form a network in hardened cement mortar, which will add self-sensing ability to the produced mortar. The disclosed methods allow for avoiding the need for dispersing CNTs using chemical functionalization and/or sonication.

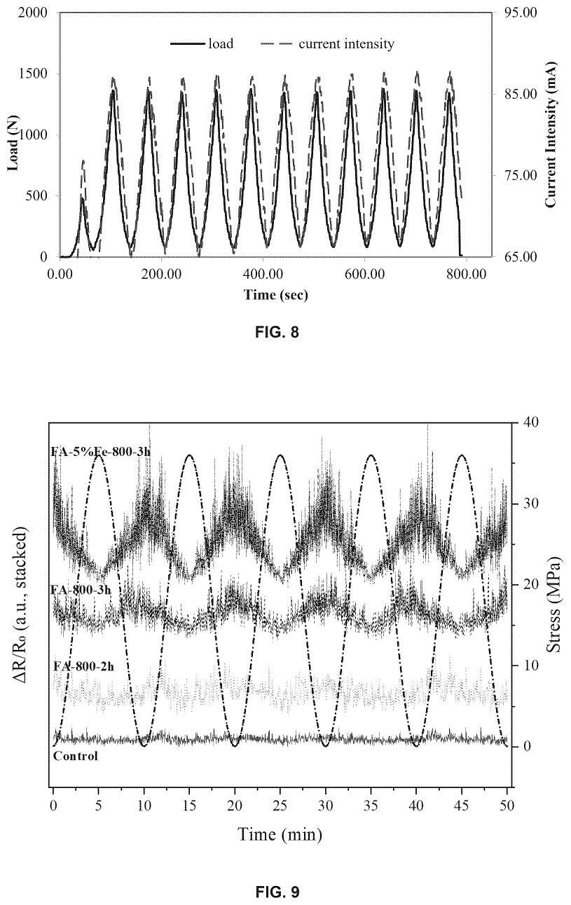

A four-electrode-DC method is employed to evaluate the self-sensing function of the mortar samples. The specimens having dimensions of 20 mm×20 mm×50 mm were made with four electrodes 20 mm (inside pair) and 40 mm (outside pair) apart from each other (FIG. 7A). A 5 V DC generated by an Agilent 33220A wave generator was applied to two electrodes, and an Agilent 34410A 6 ½ digit multi-meter was used to measure the electric current from another two electrodes. The entire specimen was subjected to a compressive load using an MTS QTEST/25 machine. The entire testing set-up is shown in FIG. 7B. A cyclic load was then applied to the specimen. In the meantime, the specimen's current was measured with a multimeter to determine the change in its resistivity over a predetermined time (FIG. 8).

### Example 5

The reactivity of the activated aluminosilicate was evaluated by R3 testing.

The R3 test (Rapid, Reliable, Relevant) is a standardized method (ASTM C1897) used to rapidly evaluate the chemical reactivity of supplementary cementitious materials (SCMs), such as calcined clay, fly ash, or slag, by measuring heat release or chemically bound water in a calcium hydroxide-rich, cement-pore-solution-simulated system. The test is conducted under accelerated conditions (typically 40° C. for 1-7 days) to isolate and accelerate the SCM reaction, providing a rapid and reliable indicator of pozzolanic or hydraulic activity. As a result, it serves as an efficient alternative to long-term strength testing, enabling quick screening of SCM performance and helping predict their contribution to strength development and durability in blended cement and concrete systems

The red clay after CNT growth shows a heat release of 253.4 J/g and calcium hydroxide (CH) consumption of 99.1 g per 100 g of solid (Table 1). Given the relatively low clay content of the starting soil and typical R3 values for metakaolin, these results suggest that most of the clay fraction was converted into a highly reactive pozzolanic phase during methane pyrolysis. Notably, the same soil calcined at 850° C. shows R3 heat release and CH consumption similar to those of the red clay after CNT growth. This indicates that coupling methane pyrolysis with in-situ catalyst formation does not compromise aluminosilicate activation and provides the additional benefit of producing CNT-integrated cSCM.

TABLE 1
R3 Testing confirming pozzolanic reactivity

| | Heat Release | Ca(OH)₂ consumption |
|---|---|---|
| Sample | (J/g SCM) | (g/100 g SCM) |
| Calcined soil | 255.5 | 106.8 |
| cSCM | 253.4 | 99.1 |

A cement mortar with the produced CNT-integrated fly ash was made. The self-sensing results for the resulting concrete, as measured by R3, are shown in FIG. 9. It can be seen that replacing 5% OPC with the produced CNT-integrated cSCM exhibits measurable conductive/self-sensing behavior. This demonstrates that CNT-on-host architectures can impart multifunctionality while preserving cementitious reactivity, overcoming a major barrier to scalable CNT deployment in infrastructure materials.

### EXEMPLARY ASPECTS

Example 1. A method comprising: (a) calcining a feedstock material in a reactor, wherein the feedstock material comprises: (i) a metal-containing solid material and/or a metal oxide-containing solid material, and (ii) a reactive gas configured to react to form a solid carbon, wherein the reactive gas comprises a methane and optionally carbon dioxide; wherein calcining is performed at a temperature of 500° C. to 1450° C.; (b) forming a first amount of hydrogen and a supplementary cementitious material (SCM), wherein the supplementary cementitious material comprises a solid carbon dispersed within the metal-containing solid material and/or the metal oxide-containing solid material.

Example 2. The method of any of the examples herein, particularly Example 1, wherein the metal-containing solid material and/or the metal oxide-containing solid material comprises one or more transition metals or oxides thereof.

Example 3. The method of any of the examples herein, particularly Example 2, wherein the transition metal or oxide thereof comprises iron, nickel, cobalt, copper, or any combination thereof.

Example 4. The method of any of the examples herein, particularly any one of Examples 1-3, wherein the solid carbon comprises carbon nanotubes, carbon nanofibers, carbon fibers, graphite, or any combination thereof.

Example 5. The method of any of the examples herein, particularly any one of Examples 1-4, wherein the metal-containing solid material and/or the metal oxide-containing solid material further comprises an amount of silicate, an amount of aluminum oxide, or a combination thereof.

Example 6. The method of any of the examples herein, particularly any one of Examples 1-5, wherein the metal-containing solid material and/or the metal oxide-containing solid material comprises industrial waste, mining waste, clay, soil, minerals comprising at least 0.5% of a metal oxide, or any combination thereof.

Example 7. The method of any of the examples herein, particularly any one of Examples 1-6, wherein the metal-containing solid material and/or the metal oxide-containing solid material comprises iron ore tailings, steel slag, copper slag, nickel slag, mine tailings, coal combustion residue, red clay, bauxite residue, cobalt slag, or any combination thereof.

Example 8. The method of any of the examples herein, particularly any one of Examples 1-7, wherein the reactive gas is sourced from natural sources, agriculture processing, fossil fuels processing, landfills, industrial processing, combustion processing, or any combination thereof.

Example 9. The method of any of the examples herein, particularly any one of Examples 1-8, wherein the metal-containing solid material and/or the metal oxide-containing solid material behaves as a first catalyst to form the solid carbon.

Example 10. The method of any of the examples herein, particularly any one of Examples 1-9, wherein the method further comprises adding a second amount of hydrogen to the reactor.

Example 11. The method of any of the examples herein, particularly Example 10, wherein the second amount of hydrogen is added before the addition of the reactive gas, or after the addition of the reactive gas, or both.

Example 12. The method of any of the examples herein, particularly any one of Examples 10 or 11, wherein the metal-containing solid material and/or the metal oxide-containing solid material is pretreated with the second amount of hydrogen gas at temperatures of 400° C.-1000° C. for a predetermined time before exposure to the reactive gas.

Example 13. The method of any of the examples herein, particularly Examples 9-12, wherein the reactor further comprises an amount of a second catalyst that is added separately, and wherein the second catalyst is substantially different from the first catalyst.

Example 13. The method of any of the examples herein, particularly Examples 1-12, wherein the reactive gas catalyzes the reduction of one or more metal oxides in the metal oxide-containing solid material to one or more metals to form a first catalyst.

Example 15. The method of any of the examples herein, particularly any one of Examples 1-14, wherein the first amount of hydrogen is collected.

Example 16. The method of any of the examples herein, particularly any one of Examples 1-15, wherein a portion of the first amount of hydrogen is used to heat the reactor.

Example 17. The method of any of the examples herein, particularly any one of Examples 1-16, wherein a volume ratio of reactive gas to the metal-containing solid material and/or the metal-oxide-containing solid material is 0.1:1 to 10000:1.

Example 18. The method of any of the examples herein, particularly any one of Examples 1-17, wherein the calcining is done for 1 min to 100 h.

Example 19. The method of any of the examples herein, particularly any one of Examples 1-18, wherein the reactor is a fluidized bed reactor.

Example 20. The method of any of the examples herein, particularly any one of Examples 1-18, wherein the reactor is a flow reactor.

Example 21. The method of any of the examples herein, particularly any one of Examples 1-18, wherein the reactor is a continuous reactor (e.g., roll-to-roll reactors, moving vibrating reactors) for a solid-gas contact.

Example 22. The method of any of the examples herein, particularly any one of Examples 1-21, wherein the supplementary cementitious material exhibits pozzolanic reactivity.

Example 23. The method of any of the examples herein, particularly any one of Examples 1-22, wherein the supplementary cementitious material is at least partially electrically conductive.

Example 24. The method of any of the examples herein, particularly any one of Examples 1-25, wherein the supplementary cementitious material is at least partially thermally conductive.

Example 25. The method of any of the examples herein, particularly any one of Examples 1-24, wherein the method is carbon neutral.

Example 26. The method of any of the examples herein, particularly any one of Examples 1-25, wherein the method is resource positive.

Example 27. The method of any of the examples herein, particularly any one of Examples 1-26, wherein the method is energy positive.

Example 28. A blended cement comprising: greater than 0 to less than 100 wt % of cement and greater than 0 to less than 100 wt % of the supplementary cementitious material made by the methods of any one of Examples 1-27, based on a total weight of the blended cement.

Example 29. The blended cement of any of the examples herein, particularly Example 28, further comprising greater than 0 to less than 50 wt % of limestone, and greater than 0 to less than 20 wt % of gypsum-based on a total weight of the blended cement.

Example 30. A method of forming a concrete, wherein the method comprises mixing the blended cement of any of the examples herein, particularly Example 28 or 29 with an amount of aggregates and water to produce the concrete.

Example 31. The method of any of the examples herein, particularly Example 30, wherein a ratio of the water to the blended cement is from 0.1 to less than 1.

Example 32. The method of any of the examples herein, particularly any one of Examples 30-31, wherein the concrete further comprises an amount of active agents and/or reagents, fillers, or any combination thereof.

Example 33. An article comprising the concrete formed by the method of any of the examples herein, particularly any one of Examples 30-32.

Example 34. The article of any of the examples herein, particularly Example 33, wherein the article is formed by casting the concrete, pumping the concrete, or any combination thereof.

Example 35. The article of any of the examples herein, particularly Examples 33 or 34, wherein the article exhibits a compression strength of 500 psi to 25 ksi.

Example 36. The article of any of the examples herein, particularly any one of Examples 32-34, wherein the article exhibits a compression strength of at least 7% higher than a compression strength of a substantially identical reference component or article in the absence of the supplementary cementitious material made by the methods of any of the examples herein, particularly any one of Examples 1-27.

Example 37. The article of any of the examples herein, particularly any one of Examples 33-36, wherein the article is at least partially electrically conductive, thermally conductive, or a combination thereof.

Example 38. A supplementary cementitious material formed by the methods of any of the examples herein, particularly any one of Examples 1-27.

Example 39. A supplementary cementitious material comprising a metal-containing solid material and/or metal oxide-containing solid material, wherein an amount of a solid carbon is dispersed within the metal-containing solid material and/or metal oxide-containing solid material, and wherein the metal-containing solid material and/or the metal oxide-containing solid material comprises iron ore tailings, steel slag, copper slag, nickel slag, mine tailings, coal combustion residue, red clay, bauxite residue, cobalt slag, or any combination thereof.

Example 40. The supplementary cementitious material of any of the examples herein, particularly Example 39, wherein the supplementary cementitious material is at least partially electrically conductive, thermally conductive, or a combination thereof.

Example 41. A concrete composition comprising the blended cement of any of the examples herein, particularly any one of Examples 28-30, an amount of aggregates, and water, and wherein a weight ratio of water to the blended cement is from 0.1 to less than 1.

Example 42. The concrete composition of any of the examples herein, particularly Example 41, wherein the concrete composition further comprises an amount of active agents and/or reagents, fillers, or any combination thereof.

Example 43. The concrete composition of any of the examples herein, particularly any one of Examples 41-42, wherein the concrete composition is at least partially electrically conductive, thermally conductive, or a combination thereof.

Example 44. The concrete composition of any of the examples herein,

particularly any one of Examples 44-43, wherein the concrete composition is recyclable.

Example 45. An article comprising the concrete composition of any of the examples herein, particularly any one of Examples 41-44.

Example 46. The article of any of the examples herein, particularly Example 45, wherein the article exhibits a compression strength of 500 psi-25 ksi.

Example 47. The article of any of the examples herein, particularly any one of Examples 45-46, wherein the article is at least partially electrically conductive, thermally conductive, or a combination thereof.

Example 48. The article of any of the examples herein, particularly Example 47, wherein an electrical conductivity of the article changes with a strain and/or damage.

Example 49. The article of any of the examples herein, particularly any one of Examples 45-48, wherein the article is a building component, a road component, a storage component, a bridge component, or any combination thereof.

Example 50. A building component comprising the concrete composition of any of the examples herein, particularly any one of Examples 41-44.

Example 51. A building component comprising the article of any of the examples herein, particularly any one of Examples 45-49.

Example 52. A method of recycling the concrete composition of any of the examples herein, particularly any one of Examples 41-44, wherein the method comprises: heating the concrete composition through Joule heating to generate an internal heat and, thereby, forming a concrete composition deformation.

Example 53. The method of any of the examples herein, particularly Example 52, wherein the concrete composition deformation comprises a plurality of cracks.

Example 54. The method of any of the examples herein, particularly Example 52 or 53, further comprising a mechanical separation of the deformed concrete composition.

Example 55. The method of any of the examples herein, particularly Example 54, wherein the mechanical separation comprises a physical crushing of the concrete composition, crushing by vibration, or any combination thereof.

Example 56. The method of any of the examples herein, particularly Example 54 or 55, wherein the mechanical separation results in a formation of aggregates and a cement paste that are separated from each other.

Example 57. The method of any of the examples herein, particularly Example 56, further comprises heating the cement paste to dehydrate hydration products present in the cement paste to form a dehydrated cement paste.

Example 58. The method of any of the examples herein, particularly Example 57, further comprising reducing the dehydrated cement paste to a plurality of particles.

Example 59. The method of any of the examples herein, particularly Examples 57 or 58, using the dehydrated cement paste in a new cement composition as a supplementary cementitious material.

What is claimed is:

1. A method comprising:
a) calcining a feedstock material in a reactor, wherein the feedstock material comprises:
i) a metal-containing solid material and/or a metal oxide-containing solid material, and
ii) a reactive gas configured to react to form a solid carbon, wherein the reactive gas comprises a methane and optionally carbon dioxide and/or carbon monoxide; wherein the calcining is performed at a temperature of 500° C. to 1450° C.; and
b) forming a first amount of hydrogen, and a supplementary cementitious material (SCM), wherein the supplementary cementitious material comprises the solid carbon dispersed within the metal-containing solid material and/or the metal oxide-containing solid material;
wherein the metal-containing solid material and/or the metal oxide-containing solid material comprises one or more transition metals or oxides thereof; and
wherein the solid carbon comprises carbon nanotubes, amorphous carbon, carbon flakes, graphene, carbon nanofibers, carbon fibers, graphite, or any combination thereof.

2. The method of claim 1, wherein the metal-containing solid material and/or the metal oxide-containing solid material further comprises an amount of silicate, an amount of aluminum oxide, or a combination thereof.

3. The method of claim 1, wherein the metal-containing solid material and/or the metal oxide-containing solid material comprises industrial waste, mining waste, clay, soil, minerals comprising at least 0.5% of a metal oxide, or any combination thereof, or wherein the metal-containing solid material and/or the metal oxide-containing solid material comprises iron ore tailings, steel slag, copper slag, nickel slag, mine tailings, coal combustion residue, red clay, bauxite residue, cobalt slag, or any combination thereof; and wherein the metal-containing solid material and/or the metal oxide-containing solid material behaves as a first catalyst to form the solid carbon.

4. The method of claim 1, wherein the methane gas is sourced from natural sources, agriculture processing, fossil fuels processing, landfills, industrial processing, combustion processing, or any combination thereof.

5. The method of claim 1, wherein the method further comprises adding a second amount of hydrogen to the reactor, and wherein the second amount of hydrogen is added before the addition of the reactive gas, or after the addition of the reactive gas, or both.

6. The method of claim 5, wherein the metal-containing solid material and/or the metal oxide-containing solid material is pretreated with the second amount of hydrogen gas at temperatures of 400° C.-1000° C. for a predetermined time before exposure to the reactive gas.

7. The method of claim 3, wherein the reactor further comprises an amount of a second catalyst that is added separately, and wherein the second catalyst is substantially different from the first catalyst.

8. The method of claim 1, wherein the first amount of hydrogen is collected, and/or a portion of the first amount of hydrogen is used to heat the reactor.

9. The method of claim 1, wherein a volume ratio of methane to the metal-containing solid material and/or the metal oxide-containing solid material is 0.1:1 to 10000:1.

10. The method of claim 1, wherein the reactor is a fluidized bed reactor, and/or wherein the reactor is a flow reactor, and/or wherein the reactor is a continuous reactor for a solid-gas contact.

11. The method of claim 1, wherein the supplementary cementitious material exhibits pozzolanic reactivity, and/or wherein the supplementary cementitious material is at least partially electrically conductive, and/or wherein the supplementary cementitious material is at least partially thermally conductive.

12. The method of claim 1, wherein the method is carbon neutral, and/or wherein the method is resource-positive and/or energy-positive.

13. A blended cement comprising:
greater than 0 to less than 100 wt % of cement and greater than 0 to less than 100wt % of the supplementary cementitious material made by the methods of claim 1, based on a total weight of the blended cement.

14. The blended cement of claim 13, further comprising greater than 0 to less than 50 wt % of limestone, and greater than 0 to less than 20 wt % of gypsum, based on a total weight of the blended cement.

15. A method of forming a concrete, wherein the method comprises mixing the blended cement of claim 13 with an amount of aggregates and water to produce the concrete, wherein a ratio of the water to the blended cement is from 0.1 to less than 1.

16. An article comprising the concrete formed by the method of claim 15, wherein the article is formed by casting the concrete, pumping the concrete, or any combination thereof, and/or wherein the article exhibits a compression strength of 500 psi to 25 ksi, and/or wherein the article is at least partially electrically conductive, thermally conductive, or a combination thereof; and/or wherein the article exhibits a compression strength of at least 7% higher than a compression strength of a substantially identical reference component or article in the absence of the supplementary cementitious material made by a method comprising:
a) calcining a feedstock material in a reactor, wherein the feedstock material comprises:
i) a metal-containing solid material and/or a metal oxide-containing solid material, and
ii) a reactive gas configured to react to form a solid carbon, wherein the reactive gas comprises a methane and optionally carbon dioxide and/or carbon monoxide; wherein the calcining is performed at a temperature of 500° C. to 1450° C.; and
b) forming a first amount of hydrogen, and a supplementary cementitious material (SCM), wherein the supplementary cementitious material comprises the solid carbon dispersed within the metal-containing solid material and/or the metal oxide-containing solid material;
wherein the metal-containing solid material and/or the metal oxide-containing solid material comprises one or more transition metals or oxides thereof;
and wherein the solid carbon comprises carbon nanotubes, amorphous carbon, carbon flakes, graphene, carbon nanofibers, carbon fibers, graphite, or any combination thereof.

17. A supplementary cementitious material formed by the methods of claim 1.

18. A supplementary cementitious material comprising a metal-containing solid material and/or a metal oxide-containing solid material, wherein an amount of a solid carbon is dispersed within the metal-containing solid material and/or the metal oxide-containing solid material, and wherein the metal-containing solid material and/or the metal oxide-containing solid material comprises iron ore tailings, steel slag, copper slag, nickel slag, mine tailings, coal combustion residue, red clay, bauxite residue, cobalt slag, or any combination thereof, and wherein the supplementary cementitious material is at least partially electrically conductive, thermally conductive, or a combination thereof.

19. A concrete composition comprising the blended cement of claim 13, an amount of aggregates, and water, and wherein a weight ratio of water to the blended cement is from 0.1 to less than 1, and wherein the concrete composition is recyclable.

20. An article comprising the concrete composition of claim 19, wherein the article exhibits a compression strength of 500 psi-25 ksi, and/or wherein the article is at least partially electrically conductive, thermally conductive, or a combination thereof, wherein an electrical conductivity of the article changes with a strain and/or damage.

21. A method of recycling the concrete composition of claim 19, wherein the method comprises:
heating the concrete composition through Joule heating to generate an internal heat and, thereby, forming a concrete composition deformation,
wherein the concrete composition deformation comprises a plurality of cracks.

22. The method of claim 21, further comprising a mechanical separation of the deformed concrete composition, and wherein the mechanical separation results in a formation of aggregates and a cement paste that are separated from each other.

23. The method of claim 22 further comprises:
a) heating the cement paste to dehydrate hydration products present in the cement paste to form a dehydrated cement paste;
b) reducing the dehydrated cement paste to a plurality of particles;
c) using the dehydrated cement paste in a new cement composition as a supplementary cementitious material.
